(19) United States
(12) Patent Application Publication
(10) Pub. No.: US 2012/0228375 A1
(43) Pub. Date: Sep. 13, 2012

(54) e-card (Electronic debit and credit cards systems)

(76) Inventor: Abiodun Daniel Iwaloye, Hamilton Parish (BM)

(21) Appl. No.: 13/118,534

(22) Filed: May 30, 2011

Related U.S. Application Data
(60) Provisional application No. 61/450,254, filed on Mar. 8, 2011.

(51) Int. Cl. G06K 19/073; G07F 19/00

(52) U.S. Cl. 235/379; 235/492

(57) ABSTRACT

Electronic credit and debit cards systems intended to reduce credit and debit cards frauds through the use of variability of features, numbers and security values on the credit or debit card by electronic means or methods. It also doubles as a security token for user authentication for online access to the credit or debit cards account.

### CROSS REFERENCE TO RELATED APPLICATION

This invention is a continuation-in-part of U.S. utility application No. 61/450,254, filed Mar. 8, 2011. The aforementioned application is hereby incorporated herein by reference in its entirety.

### FIELD OF THE INVENTION

The present invention relates to electronic credit and debit cards systems providing increased security for users while also doubling as a security token for online access.

### BACKGROUND OF THE INVENTION

The invention relates to credit and debit cards system and more particularly to credit and debit cards systems with facilities for the numbers on the credit and debit particularly the card verification value or card verification code “CVV” to be electronic and which is constantly changing after successful execution of each transaction especially over the phone or the internet and/or at the prompt of the owner i.e. the CVV is a series of numbers rather than a specific number and changes at the prompt of the card user whenever they want to do so. The next CVV that is displayed is either already pre-programmed onto the card at issuance or is randomly generated. The CVV is electronically displayed and disappears after a period of time has elapsed. The same applies to all other electronic numbers or features on the card.

In its present state, credit and debit cards have a fixed CVV, credit and debit card numbers and all the other numbers and features on the credit or debit card are fixed and cannot be varied unless the credit or debit card is replaced or changed.

It is the object of the proposed invention for certain features such as the CVV or the credit or debit card number, on the credit and debit cards to be electronic and variable or changeable at the prompt of the card holder or legitimate owner.

It is also the objective of the invention is to help reduce credit or debit card frauds by ensuring that only the rightful owner of credit or debit cards uses them for transactions over the phone, the intemet or at point of sale outlets. With an increase in the number of unauthorised transactions on credit or debit card without the owners' consent, creating a lot of worries for banks and also an increase in the number of frauds on credit or debit cards due to stolen credit or debit card details.

The existing system of using credit and debit cards has lapses as giving one's credit or debit card details over the phone or the Internet jeopardizes the integrity of the card because the same person that got the details over the phone or the internet can use them to perpetrate fraud by repeating the process just as he/she has obtained it for the current transaction for a subsequent transaction without the consent of the owner.

It is also the objective of the invention to have all the electronically variable features and numbers programmed and stored on the cards at the time of card issuance and for the card to have a wifi or other means of communicating with the issuer or other point of sale outlets such as an ATM machine or a computer device the currently displayed features or numbers on the credit or debit card or for the electronically variable features to be randomly generated.

It is further the objective of the invention to have facilities for numbers letters or a combination of both that serves as a security token for user authentication for online access to the account of the card holder.

### DESCRIPTION OF THE INVENTION

The e-card has all the parts of the existing credit and debit cards with an electronic panel for displaying the CVV and a push button to activate and or change the CW either a solar panel or a flat battery to power the device.

The e-card can also be modified so that all the numbers and letters on the card are electronically displayed and can be varied or changed.

The card can be further modified and programmed to recognise finger prints of the owner and can only be activated by that finger print or through the use of the pin number for withdrawing cash from the credit or debit card.

For example, a series of CW or other features like the card number are programmed on the card at the point of issuance. When a card holder completes a transaction over the telephone and gives the card details over the phone or over the internet, the current electronic CW displayed on the card is given to the vendor. The vendor makes a claim from the cardholder's bank and they check the CVV with the programmed number on their system as it relates to that client and then confirms it is the next number in the series before the transaction is approved for payment. If the number is out of sequence the bank will confirm the transaction with the card holder to verify it.

When the card holder uses an ATM or accesses the banking system and the most recent features on the card can be captured and stored by the banking system and this serves to authenticate the transaction. Alternatively, the card might have a means of transferring the current CW to the banking system either through the use of wifi or bluetooth or other electronic means.

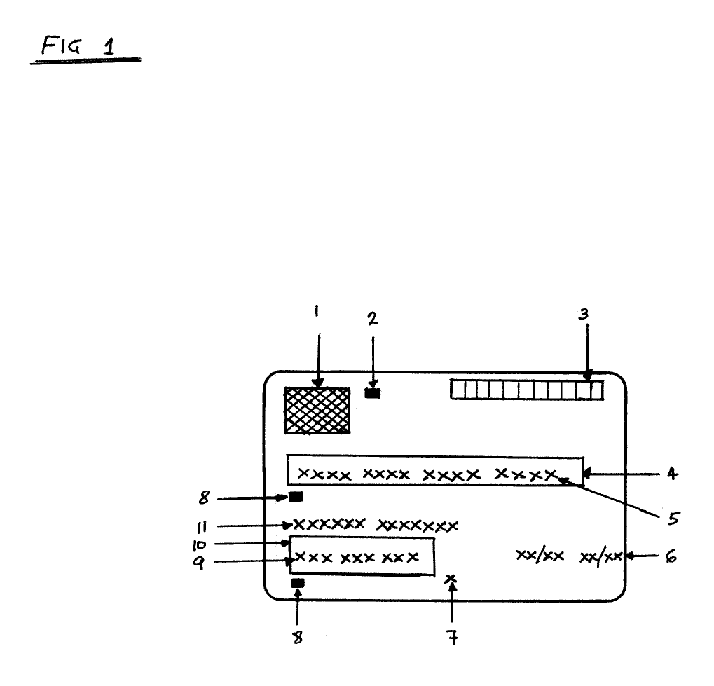

FIG. 1 is a schematic representation of the front view of the e-card in accordance with the present invention. The detailed descriptions are as follows:

1. Microchip for information storage

2. Wifi button for wireless communication

3. Solar panel or battery to power the invention

4. Electronic display panel for card number

5. Card number

6. Issue and expiry dates

7. Issue number

8. Prompt to change display

9. Account number

10. Electronic display panel for account number

11. Card holder's name

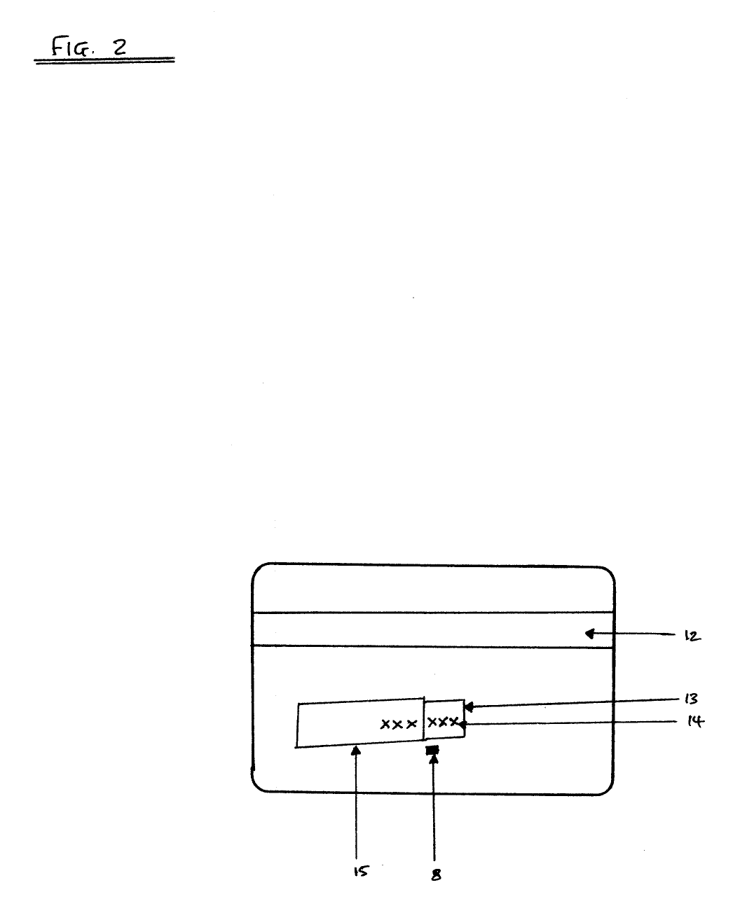

FIG. 2 is a schematic representation of the rear view of the e-card in accordance with the present invention. The detailed descriptions are as follows:

12. Magnetic strip

13. Electronic display panel for CVV

14. CVV

15. Signature panel

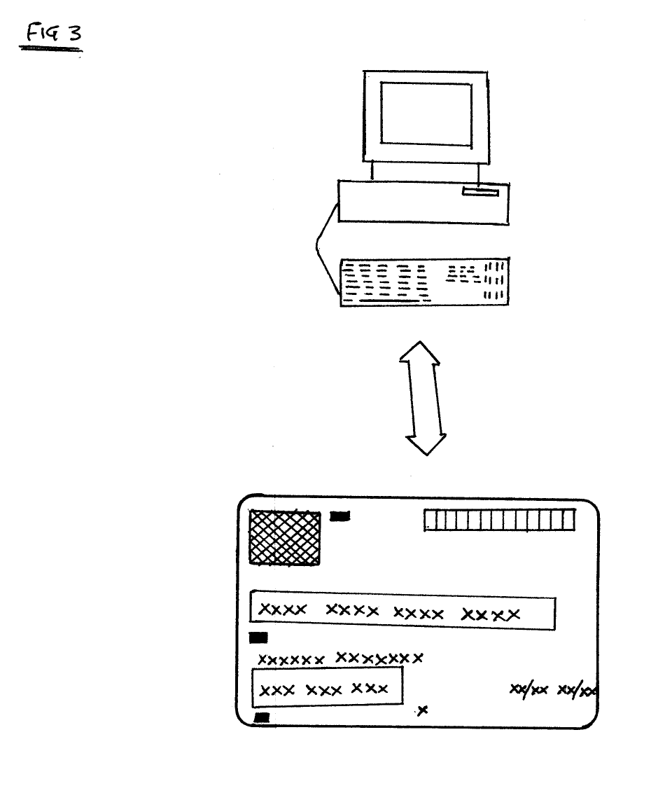

FIG. 3 is a schematic representation of the communication between an e-card of FIG. 1 and FIG. 2 and a personal computer in its use as a security token for online access to the card account.

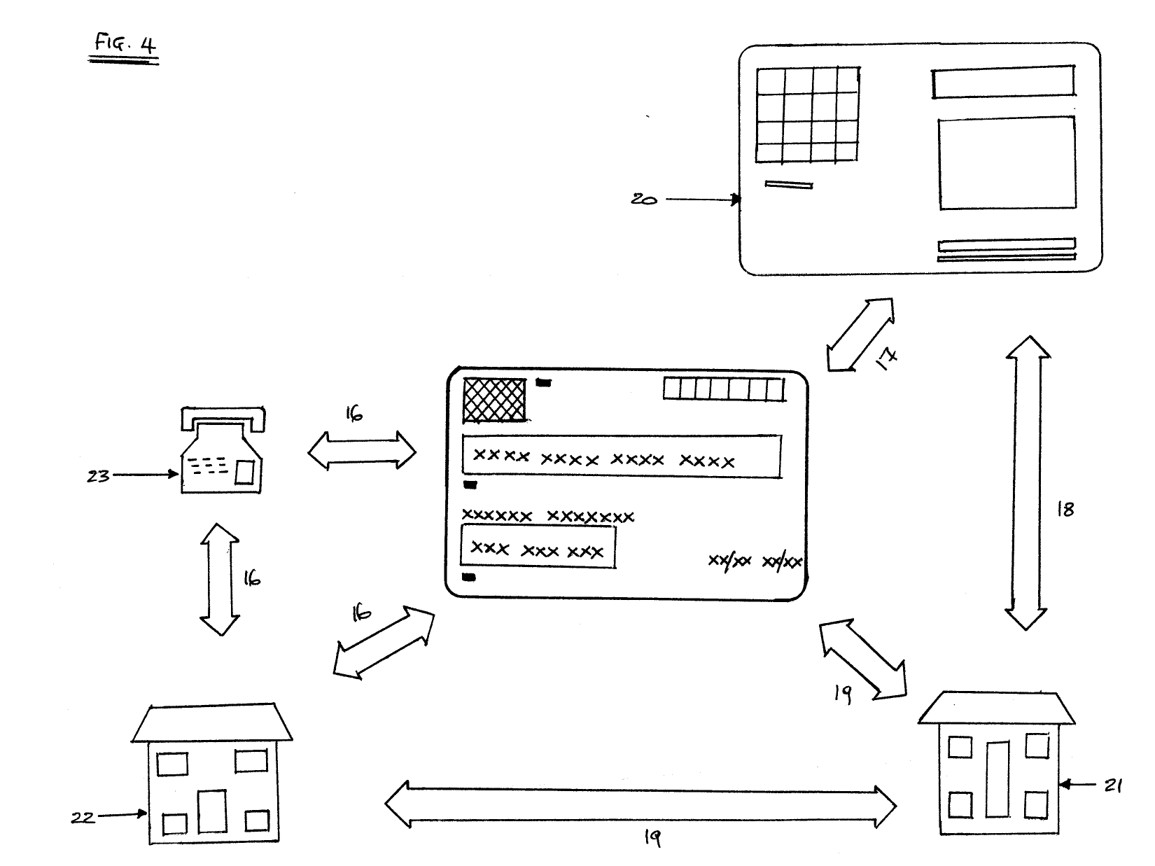

FIG. 4 is a schematic representation of the communication between an e-card of FIG. 1 and FIG. 2 and an ATM or other point of sale system and the card issuer's database system for capturing the last used details on the card to the card issuer.

16. The process whereby the card details are given to a vendor or merchant either directly or through a communication device or method.

17. The process whereby the currently displayed details on the card are captured

18. The process whereby the captured details are communicated to or retrieved by the banking system

19. The process whereby the bank having confirmed the captured details in Step 3 or by direct confirmation with the card holder approves the transaction and pay the vendor or merchant.

20. Automated teller machine (ATM) and or point of sale (POS) outlet or system.

21. Bank or card issuer.

22. Vendor or merchant.

23. Telephone or mobile communication device.

What is claimed:

010. whereas the existing system of credit and debit cards has a fixed cvv on the back of the card, the proposed system will have an electronic cvv that can change: This CVV generates one of a series or sequence of numbers that would have been programmed into the card by the banking system or computer at the time that the card was issued and the next number in the sequence will not be allowed to process another transaction until the current sequence has been used and checked off by the bank as used unless subject to a confirmation of an over ride by the card owner to the banking system.

011. Whereas the existing system of credit and debit cards has a fixed number on the front of the card, the proposed system will have an electronic card number that can be changed. This card number generates one of a series or sequence of numbers that would have been programmed into the card by the banking system or computer at the time that the card was issued and the next number in the sequence will not be allowed to process another transaction until the current sequence has been used and checked off by the bank as used unless subject to a confirmation of an over ride by the card owner to the banking system

012. The card number and the CVV can be both matched such that they both change together or they can have features for each to be individually varied.

013. Whereas the existing credit and debit cards system do not have facilities for additional features for security tokens for user authentication. It is intended that the current invention will have facilities for such features.

014. The continuously changing features numbers or letters are activated at the touch of a button and are shown on an electronic display for a certain period of time before they disappear.

015. It is intended that the e-card might also use radio frequency identification (rfid), wifi, bluetooth or other communication technology to transfer the numbers generated at the time of each transaction to the bank that issued the card as a mean of authenticating the request of the user before the transaction can be completed. The same number is given to the vendor from whom purchase of merchandise is sought.

016. It is intended that the CVV will be numbers or letters or a combination of both which are randomly generated and once given to a vendor might be transmitted to the system of the bank that issued the credit or debit card to authenticate transaction.

017. It is intended that the CVV can be used with a unique number, letter or combination of both given to the card owner at the time that the card was issued or created by the user based on unique attributes. These numbers, letters or combination of both creates an extra step that helps improve the security of the rightful owner of the card in proving their identity.

018. The existing system makes the credit or debit card prone to fraud as anyone else with all the details on the credit or debit card can use the card to complete the same transaction fraudulently just like the rightful owner, the proposed system has a series of CVV that is dynamic and changes, making it difficult for anyone else to have exactly the same details to authenticate transactions especially over the phone or internet.

019. The invention serves to authenticate the identity of the credit or debit card owner as the rightful owner and not some bogus or fraudulent vendor that has obtained the details dishonestly and is trying to use it to complete a transaction without the consent of the rightful owner. This will help to reduce credit or debit cards frauds. This invention can be used in both credit cards and debit cards.

20. Either a series or sequence of numbers that have been programmed into the credit and debit card by the issuer's system at the time of issuing the credit or debit card or a series of randomly generated numbers that is sent to the issuer through some communication means once activated on the card either through wifi, bluetooth or other communication technology or the number is generated and stored on the card and at the next point of using the card at an ATM machine or accessing the banking system is transferred through the account of the customer to the bank for authenticating the request over the phone or the internet.
